(19) United States
(12) Patent Application Publication
(10) Pub. No.: US 2015/0136917 A1
(43) Pub. Date: May 21, 2015

(54) REFRACTORY CASTING TUBE FOR A MOULD FOR CONTINUOUSLY CASTING MOLTEN METAL

(71) Applicant: SMS CONCAST AG, Zurich (CH)

(72) Inventor: Christian Dratva, Zurich (CH)

(21) Appl. No.: 14/396,432

(22) PCT Filed: Apr. 26, 2013
(86) PCT No.: PCT/EP2013/058815

§ 371 Date: Oct. 23, 2014

(30) Foreign Application Priority Data
Apr. 26, 2012 (EP) 12002962.4

(51) Int. Cl. B22D 11/103; F16M 11/32; B22D 11/106

(52) U.S. Cl. CPC B22D 11/103; B22D 11/106; F16M 11/32
USPC 248/157; 164/437; 164/412; 248/163.1

(57) ABSTRACT

A refractory casting tube for a mould for continuously casting molten metal is provided with a top part (33) and a bottom part (35) which dips into the molten metal in the inner mould space (6) during the casting. A refractory deflection element (35) is integrated in the funnel-shaped or similarly shaped inlet (34) of the top part (33) and is shaped in such a manner that a fluid-dynamic dissipation is generated on the molten metal (21) during casting in said inlet (4, 34). The molten steel therefore flows into the mould roughly as a uniform flow with a homogeneous and stable distribution.

The invention relates to a refractory casting tube for a mould for continuously casting molten metal according to the preamble to claim 1.

It is well known that casting tubes of this type are used to convey the molten metal from a casting vessel into the mould in which it is cooled in order to form the metal strand. In continuous casting one is constantly striving for faster casting speeds. However, the faster the casting, the faster and the more uniformly the shell of the strand must also develop within the mould in order to form a solidified strand shell with sufficient strength. In order to guarantee this, the distribution of the molten metal within the mould must be controlled precisely.

Higher casting speeds and higher quality characteristics such as the surface quality, core porosity, segregation, degree of purity etc. should be achieved for a wide range of different metal qualities.

With so-called “open casting”, wherein the molten metal is poured from an intermediate container or the like into the mould by means of a free-flow nozzle, the pouring stream within the molten bath generated by the latter causes uncontrollable turbulence within the mould. However, the free-falling pouring stream causes uncontrollable flow conditions within the molten pool due to which high local flow speeds of the molten metal may occur in the region of the solidification front, and so local re-melting of the strand shell may occur. Furthermore, non-homogeneous flow speed distributions within the mould may lead to non-uniform shell development. This results in undesirable distortion of the cross-sectional geometry of the strand and weak points in the continuous casting shell.

A casting system with an inlet nozzle as a spout element is disclosed by WO 2006/108874. Located between the inlet nozzle and the mould is an attachment sitting on the latter for receiving the molten steel and which is provided with one or more baffles for calming the flow of molten metal. Since the outlet opening of the attachment is flush with the upper edge of the mould, the attachment can not be dipped into the inner mould space. This type of arrangement is complex and has disadvantages both with regard to the calming effect which can be achieved with it and to the resulting problems associated with sealing between the attachment and the mould.

In contrast, it is the object of the invention to devise a refractory casting tube of the type specified at the start, with which one can achieve improved inlet flow conditions into the mould and so different advantages such as higher casting speed, reduction of the break-through rates and/or increased quality even with high specific throughputs of the continuously cast product.

According to the invention, this object is achieved in that there is integrated into the funnel-shaped or similarly-shaped inlet of the top part at least one deflection element which is shaped in such a manner that a fluid-dynamic dissipation is generated on the molten metal during casting in this inlet.

Due to the configuration according to the invention of the casting tube the molten steel flows roughly as a uniform flow with homogeneous and stable distribution into the mould. This enables a more controllable flow pattern of the molten metal and so improved shell formation within the mould, and this is even guaranteed with high casting speeds. Moreover, the upper inner mould space is protected from splashes of metal by the top part of the casting tube.

As an additional advantage, the decoupling of the outlet from the tundish into the mould should be mentioned. In this way, independently of the tundish outlet for a number of strands cast at the same time, the respective individual casting tube can be aligned optimally to the mould position.

Furthermore, the invention makes provision such that the top part of the casting tube can be supported on the mould by a casting tube holder. In this way the inner mould space can be covered by corresponding dimensioning of the inlet funnel. Moreover, the casting tube is held by separate support means or by the mould itself.

In one preferred embodiment of the invention the funnel-shaped inlet is cone-shaped. Its inner space can be totally or partially flattened.

Beneath the inlet funnel the casting tube is continuously tubular in shape. However, the casting tube can also be similar to the casting format in the lower section, for example round or rounded for square or rectangular formats, or rather flattened, for example for moulds with a widened cross-section. In both cases it can additionally be provided here with longitudinal slots at the side which contribute to the flow of molten metal into the mould being slowed down and taking place largely uniformly. Furthermore, a better exchange with the molten motel already located here within the mould is achieved.

Likewise for this purpose, according to the invention a covering plate is optionally provided which lies floating on the molten metal within the mould. It primarily brings about wave minimisation of the molten metal level. The covering plate is made in one or more parts. Preferably, it is spaced apart from the inner wall of the mould by spacers which ensure that the covering plate can not have any contact with the inner walls of the mould and so there is no negative impact upon the supply of lubricant or the shell formation within the mould. In addition, the agitator power of electromagnetic agitators and so the rotational movements of the molten metal can be increased without excessively high waves building up at the corner of the mould tube or casting aids being drawn into the molten metal.

Exemplary embodiments and further advantages of the invention are described in more detail below by means of the drawings. These show as follows:

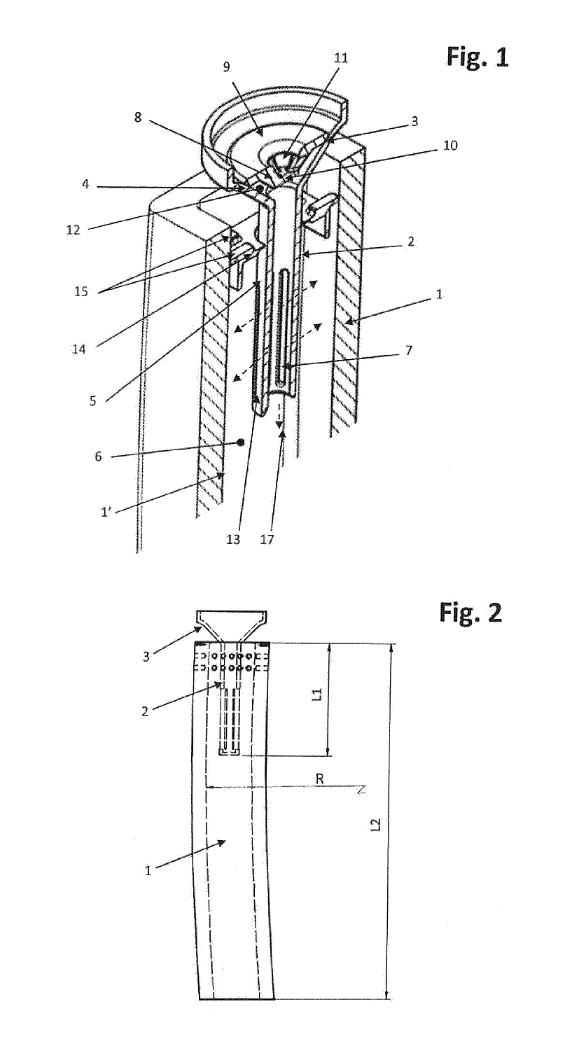

FIG. 1 shows a mould for continuously casting steel with a refractory casting tube according to the invention and a refractory covering plate, shown perspectively in partial section;

FIG. 2 is a diagrammatic side view of the mould and the casting tube according to FIG. 1; and

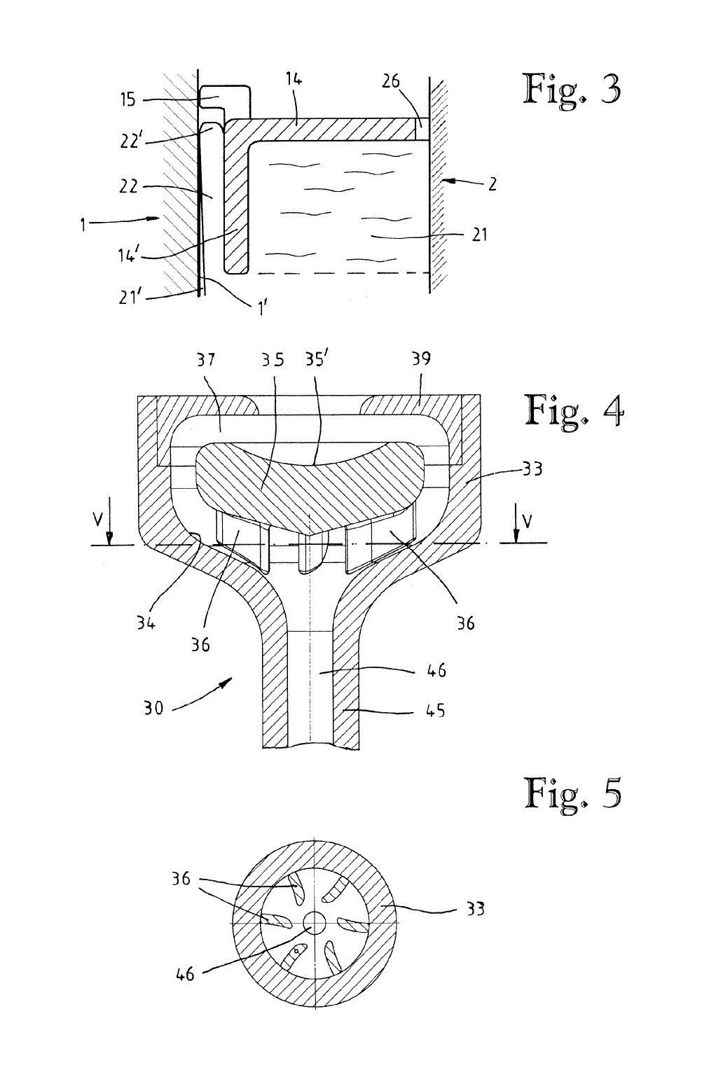

FIG. 3 is a partial section of the mould and the covering plate located within the latter according to FIG. 1;

FIG. 4 is a longitudinal section of a funnel-shaped inlet of a version of a casting tube;

FIG. 5 is a cross-section, shown scaled down, of the inlet of the casting tube according to FIG. 3 according to the line V-V; and

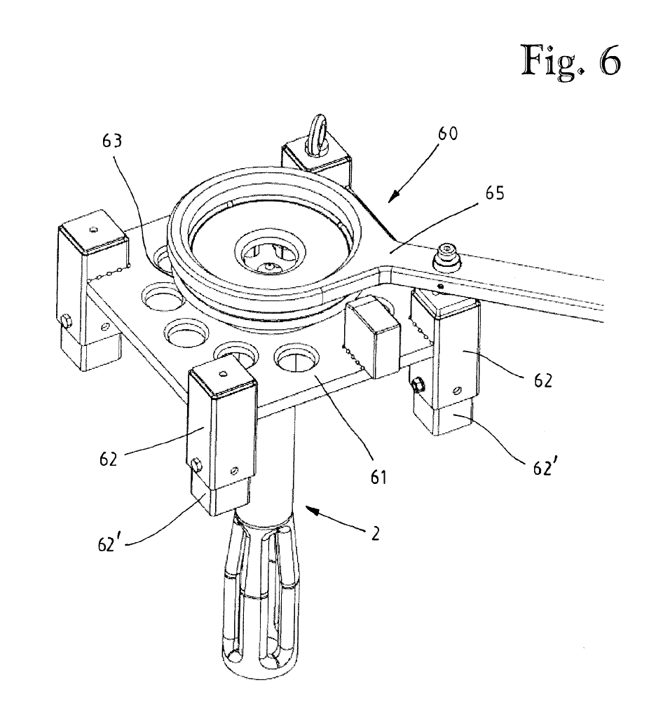

FIG. 6 is a perspective view of a holder of the casting tube.

A mould 1 according to FIG. 1 of a continuous casting system for steel production, shown in outlines, is preferably designed for high casting speeds of up to 10 m/min. The mould 1 is supplied with the molten metal, in particular steel, by a refractory casting tube 2 with a funnel-shaped inlet 4 located in the top part 3 of the casting tube and an adjoining tubular bottom part 5 which is almost entirely dipped in the inner mould space 6 during casting. The spout 7 of the casting tube is also located here. The casting tube 2 is made of a conventional ceramic material and is produced by traditional production methods.

The funnel-shaped inlet 4 can be fixed in a holder disposed above the mould 1. However, it can also be supported directly on the mould 1. The inlet funnel 4 is advantageously dimensioned with its upper outer circumference such that it enables protection of the mould 1 from splashes of the outflowing molten metal during casting. The cone-shaped inlet funnel 4 in the top part 3 with its inner space serves to accommodate the molten metal which is delivered to it from a metallurgical vessel (not shown), for example a tundish with a free-flow nozzle.

According to the invention, there is integrated into the funnel-shaped or similarly shaped inlet 4 of the top part 3 at least one deflection element 8 which is shaped in such a manner that a fluid-dynamic dissipation is generated on the molten metal during casting in this inlet 4.

Advantageously, there is located in the inner space of the funnel a deflection element 8 with an annular supporting flange 9 and a central attachment 10 which is closed at the bottom and has radial outlet openings 11 through which the molten metal flows into an intermediate space 12 of the funnel formed by the inlet funnel 4 and the deflection element 8. By means of this deflection element 8, which is preferably placed in the funnel, the kinetic energy of the molten metal is decelerated and distributed uniformly downwards into the mould.

The inlet funnel 4 according to the invention in interaction with the deflection element 8 causes the inflowing molten metal to accumulate here and to be distributed uniformly here to such an extent that it flows through the tubular section 5 and the outlet 7 into the inner mould space 2, dissipated as a homogenous flow. In this way it is possible to control the molten metal solidification process within the mould such that higher casting speeds can be achieved. The deflection element 8 can be designed such that it corresponds optimally to the respective conditions of use as regards material and/or shape.

Furthermore, two deflection elements spaced apart and arranged one over the other can also be incorporated into the inlet funnel wherein, for example, the upper plate is provided with a central opening and the lower plate is provided with a number of openings on the outside.

The casting tube 2 is continuously tubular in form below the inlet funnel 4 and has an outlet opening 17 extending downwards on the face side and longitudinal slots 13 at the side by means of which a more uniform supply of molten metal into the inner mould space is brought about.

However, the casting tube 2 could also be closed on the bottom so that the molten metal only passes out at the side. The number and the height of the longitudinal slots 13 can also be adapted optimally to the given casting parameters. This height of these longitudinal slots 13 is advantageously in the region of 100 mm.

The overall lengths of the casting tube 2 and the mould 1 are matched to one another according to FIG. 2 such that the tubular section 5 of the casting tube dips into the inner mould space 6 with the dipping depth L₁ preferably being approx. ⅓ of the length L₂ of the mould.

The aim here is for the outflowing molten metal at the outlet 7 of the casting tube to have a marginal influence upon the molten metal surface. Needless to say, this dipping depth L₁ can be varied depending on the type of mould and the casting conditions.

If, for reasons relating to process management, the new molten metal delivered via the casting tube is first of all to flow into the region close to the meniscus, the dipping depth of the casting tube can be reduced accordingly. This form of process management brings about, for example, a reduction in segregation and porosity due to the higher reduction in overheating within the mould.

According to FIG. 1 and FIG. 3, within the framework of the invention a covering plate 14 is optionally positioned floating on the molten metal with free axial movement, by means of which, in addition to protection of the molten metal level, calming of the molten metal level is also brought about. The covering plate 14 can be made in one or more parts, the latter case in particular with casting tubes with a widened outlet. It can be produced from conventional ceramic materials and be spaced apart from the inner wall 1′ of the mould by spacers 15 by a small distance in the millimetre range, these spacers 15 being positioned offset upwards in relation to the plate so that they do not come into contact with the molten metal 21. Separate guide elements could also be used as spacers. Thus, free moveability of this covering plate 14 is guaranteed in the axial direction of the mould and it is made possible to deliver lubricant, such as an oil mixture or powder, to the inner wall 1′ of the mould 1.

As can be seen from FIG. 3, the covering plate 14 is made in the shape of a cup, and for this purpose has an outer annular collar 14′. Formed between this collar 14′ and the inner wall 1′ of the mould is an annular space 22 into which the molten metal 21 can flow constantly during the casting, and so the required meniscus 22′ within the mould is guaranteed, and in this way the desired shell formation 21′ is produced. In addition, an annular gap 26 is also provided between the covering plate 14 and the casting tube 2 so that these do not touch one another during the casting.

Within the framework of the invention this covering plate 14 floating on the molten steel is very advantageously also suitable as a component of a meniscus measuring device (not shown in any more detail), with which, for example, the current molten metal height is measured visually from above the mould, by means of lasers or the like.

According to FIG. 4 and FIG. 5, in a casting tube 30 according to the invention there is integrated into the funnel-shaped or similarly shaped inlet 34 of the top part 33 at least one refractory deflection element 35 which is shaped such that fluid-dynamic dissipation is generated on the molten metal during casting in this inlet 34.

The deflection element 35 is supported by a number of bars 36 in the funnel-shaped inlet 34. There is formed between the deflection element 35 and the inlet 34 located in the top part 33 an annular flow-through channel 37, 38 extending radially outwards and consequently downwards, which then discharges into the longitudinal opening 46 of the tubular bottom part 45. Preferably inserted on the top side of the top part 33 is a refractory cover 39, open in the centre, which delimits this flow-through channel 37 and prevents the inflowing molten metal from spraying out.

The deflection element 35 has an upper surface 35′ against which the stream of molten metal flowing into the inlet 34 dashes or onto which it is deflected. This surface 35′ is in the form of a shell. Needless to say it could also be shaped differently.

The bars 36 disposed beneath the deflection element 35 and supporting the latter are aligned such that spin is generated on the downwardly flowing molten metal by means of which the molten metal passes out in an ideal manner at the slots.

With this design according to the invention of the casting tube 30 and this resulting fluid-dynamic dissipation, this uniform flow is achieved with homogeneous and stable distribution into the mould 1.

Furthermore, FIG. 6 illustrates a casting tube holder 60 which comprises a support plate 61, four outside support legs 62, a recess 63 for accommodating the casting tube 2 and a weight body 65. Assigned to the outside support legs 62 are height-adjustable base elements 62′ which lie on the mould 1 and by means of which the position of the casting tube 2 can be adjusted within the mould as regards height, but also with regard to the coaxial alignment. With the weight body 65 it is guaranteed that the casting tube is not moved upwards by the lifting force of the molten metal.

The invention is sufficiently displayed by the exemplary embodiments described above, but it could also be configured in other versions. Thus, for example, the mode of operation of the inlet funnel can be implemented independently of the configuration of the outlet at the bottom end of the casting tube. The inlet of a casting tube could also be designed in a different shape instead of a funnel, such as for example in the shape of a cup.

The deflection element in the inlet of the casting tube could also be made in a different shape. Likewise, the bottom part could also be made with a diameter that broadens or narrows rather than tubularly.

The casting tube could in principle also be supported directly on the mould in the funnel.

A bellows surrounding the stream of molten metal, forming a seal, and if need be an inert gas let into the latter can be provided in a manner which is conventional in its own right in a free-flow nozzle in the tundish located above the mould.

1. A refractory casting tube for a mould for continuously casting molten metal, comprising a top part (3, 33) with a funnel-shaped or similarly shaped inlet (4, 34) positioned above the mould (1) and comprising a bottom part (5, 35) which dips into the molten metal located in the inner mould space (6) during casting, and which is tubular or in some other shape, characterised in that there is integrated into the funnel-shaped or similarly-shaped inlet (4, 34) of the top part (3, 33) at least one refractory deflection element (8, 35) which is shaped in such a manner that a fluid-dynamic dissipation is generated on the molten metal (21) during casting in this inlet (4, 34).

2. The casting tube according to claim 1, characterised in that the at least one deflection element (8, 35) has an upper surface (35′) against which the molten metal flowing radially into the inlet (4, 34) dashes or onto which it is deflected.

3. The casting tube according to claim 1, characterised in that the deflection element (35) is supported in the funnel-shaped inlet (34) by a number of bars (36) and between the latter an annular flow-through channel (37, 38) extending radially outwards and consequently downwards is formed which then discharges into the longitudinal opening (46) of the tubular bottom part (45).

4. The casting tube according to claim 3, characterised in that there is placed on the top side of the casting tube (30) a refractory cover (39), open in the centre, which delimits this flow-through channel (37) and prevents the molten metal from splashing out.

5. The casting tube according to claim 1, characterised in that the inlet (4) contains a deflection element (8) with a support flange (9) and an attachment (10), closed on the face side (10), with at least one outlet opening (11).

6. The casting tube according to claim 1, characterised in that the bottom part (5) of the casting tube can be dipped with a length (L₁) in the mould (1), preferably by ⅓ of the mould length (L₂).

7. The casting tube according to claim 1, characterised in that the bottom part (5) of the casting tube is continuously tubular in shape and has longitudinal slots (13) or the like to the side.

8. A refractory covering plate for a mould for continuously casting molten metal and which lies within the mould on the surface of the molten metal and in particular surrounds a casting tube according to claim 1, characterised in that the one- or more part covering plate (14) can be placed in the mould (1), floating on the molten metal, such as to be able to move freely relative to the mould and to the casting tube in the axial direction of the mould.

9. The covering plate according to claim 8, characterised in that it is spaced apart from the inner wall of the mould by spacers (15) or separate guide elements, the spacers (15) being disposed above the molten metal.

10. The covering plate according to claim 8, characterised in that the covering plate, which can be placed, floating, on the molten steel, is in the form of a component of a meniscus measuring device.

11. A casting tube holder for a casting tube according to any of the claim 1, wherein the casting tube (2) can be positioned above a mould, characterised in that it comprises a support plate (61), outside support legs (62), a recess (63) for accommodating the casting tube (2) and a weight body (65).

12. The casting tube holder according to claim 11, characterised in that there are assigned to the outside support legs (62) height-adjustable base elements (62′) which lie on the mould (1) and by means of which the position of the casting tube (2) within the mould can be adjusted as regards the height, but also with regard to the coaxial alignment.
